(19) United States
(12) Patent Application Publication
(10) Pub. No.: US 2009/0014553 A1
(43) Pub. Date: Jan. 15, 2009

(54) WATER SPRAYING MOTOR

(76) Inventor: Kuan-Shiung WANG, Changhua County (TW)

Correspondence Address: Wang, Kuan-Shiung, 235 Chung-Ho, Box 8-24, Taipei, TW

(21) Appl. No.: 11/775,873

(22) Filed: Jul. 11, 2007

(51) Int. Cl. B05B 3/04

(52) U.S. Cl. 239/237

(57) ABSTRACT

A water spraying motor comprises a water inlet seat; a rotary seat; a supporting seat; and a blade wheel. Water flows into the water inlet hole of the water inlet seat. When water flows out from one of the water outlet of the supporting seat, the blade wheel will be driven; by the engagements of the gear of the water inlet seat, the gear set; the rotary seat will rotate with respect to the water inlet seat. When the rotary seat rotates to a predetermined position, an elastic driver of the rotary seat is confined by the water inlet seat so as to push the swing seat along a reverse direction and water flows out from another water outlet; and thus the rotary seat rotates reversely with respect to the water inlet seat so that the rotary seat rotates reciprocally.

### FIELD OF THE INVENTION

The present invention relates to water spray motors, and particularly to a water spraying motor, wherein a swing seat is used to switch the water flow direction so as to change the rotate direction of the blade wheel. Thereby the change direction of water flow is performed automatically without external power source.

### BACKGROUND OF THE INVENTION

In the prior art spraying device, water flows into a bi-forked tube. Two outlets of the bi-forked tube are covered alternatively so that water flows out from the bi-forked tube alternatively. Water from the outlets of the bi-forked tube will drive a water wheel to rotate along different directions reciprocally. Thus the change of the direction of the water wheel is switched automatically without needing any external power. It is a device matching the requirement of environment protection. However, in the prior art, a U ring is used. The U ring is easy to fatigue and furthermore the switching structure is installed at an outer side of the device. It is easy to destroy due to collision. Furthermore the angle for spraying water is finite and small. Furthermore the range of the angle can not be adjusted. Further only one gate is used to seal water outlet. The gate suffers from a great force and thus it is easy to bent.

Thus there is an eager demand for a novel design which can improve prior art defects.

### SUMMARY OF THE INVENTION

Accordingly, the primary object of the present invention is to provide a water spraying motor, wherein a swing seat is used to switch the water flow direction so as to change the rotate direction of the blade wheel. Thereby the change direction of water flow is automatically without external power source.

To achieve above objects, the present invention provides A water spraying motor, comprising: a water inlet seat; a bottom of the water inlet seat being installed with a gear; when the gear rotates, the water inlet seat will rotate therewith; a water inlet hole passing through the water inlet seat and the gear for filling water; a rotary seat connected to the water inlet seat and rotatable with respect to the water inlet seat; the rotary seat having a water inlet hole corresponding to the water inlet hole of the water inlet seat; the rotary seat being installed with a push hole; an elastic driver being installed in the push hole; the elastic driver including a push rod, an elastic unit, and a push sheet; a top of the elastic driver extending into the water inlet seat and being adjusted and confined by the water inlet seat; a supporting seat; a lower side of the elastic driver extending into the supporting seat; the supporting seat being installed with a supporting seat; the gear set having a plurality of gears which are interactive; a top side of the gear set is engaged to the gear of the water inlet seat; the supporting seat having two water output holes; a swing seat being installed upon the pivotal seats; the shift of the swing seat will cover one of the two water output holes; a lower side of the supporting seat being pivoted with a blade wheel; a top of the blade wheel being installed with a driving gear which is engaged to the gear set so that the blade wheel is interacted with the gear set; two water outlets being at a lower side of the supporting seat corresponding to the two water output holes; water flowing directions of the two water outlets being opposite so that the water from the two water outlets drive the blade wheel to rotate along two opposite directions. Water flows into the water inlet hole of the water inlet seat. When water flows out from one of the water outlet; the blade wheel will be driven, by the engagements of the gear of the water inlet seat, the gear set; the rotary seat will rotate with respect to the water inlet seat. When the rotary seat rotates to a predetermined position, the elastic driver is confined by the water inlet seat so as to push the swing seat along a reverse direction so that water flows out from another water outlet; and thus the rotary seat rotates reversely with respect to the water inlet seat so that the rotary seat rotates reciprocally.

The various objects and advantages of the present invention will be more readily understood from the following detailed description when read in conjunction with the appended drawing.

### BRIEF DESCRIPTION OF THE DRAWINGS

FIG. 1 is an exploded perspective view of the water spraying motor of the present invention.

FIG. 2 is a partial enlarged view showing an end portion of the supporting seat in the FIG. 1 of the present invention.

FIG. 3 is a cross section view about the water spraying motor of the present invention.

FIG. 4 is a schematic cross section view showing the top of the supporting seat of the present invention.

FIGS. 5 to 8 are schematic views showing the operation of the present invention.

FIG. 9 is a schematic view showing the use of the present invention.

FIGS. 10 to 11 are schematic views showing the operation of the present invention.

FIG. 12 is an exploded schematic view about the second embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

With reference to FIGS. 1 to 4, the spraying motor 1 of the present invention is illustrated. The present invention has the following elements.

A water inlet seat 2 is an inlet valve 24 at an upper periphery thereof for adjusting flow rate. A bottom of the water inlet seat 2 is installed with a gear 21. When the gear 21 rotates, the water inlet seat 2 will rotate therewith. A water inlet hole 22 passes through the water inlet seat 2 and the gear 21 for filling water. An outer periphery of the water inlet seat 2 is med with two limiting projections 23. One protrusion 21 is rotatable with respect to another one for limiting the space therebetween.

A rotary seat 3 is connected to the water inlet seat 2 and is rotatable with respect to the water inlet seat 2. The rotary seat 3 has a water inlet hole 31 corresponding to the water inlet hole 22 of the water inlet seat 2. The rotary seat 3 is installed with a push hole 32. An elastic driver 4 is installed in the push hole 32. The elastic driver 4 includes a push rod 41, an elastic unit 42, and a push sheet 43. A top of the push rod 41 extends into the water inlet seat 2 and is adjusted and confined by the two limiting projections 23 of the water inlet seat 2. A lateral side of the push rod 41 near a lower end has two positioning posts 44 for positioning the push rod 41 in the rotary seat 3. The push rod 41 is rotatable. A lower end of the push rod 41 is engaged with an elastic unit 42 which is a flexible elastic element. A lower end of the elastic unit 42 is installed with a moving sheet 43.

A supporting seat 5 has a spacer 55 at a top end thereof which divides the supporting seat 5 into two portions. The water inlet hole 31 of the rotary seat 3 will guide water into the supporting seat 5. The moving sheet extends into the supporting seat 5. The two portions of the supporting seat 5 are a driving area 52 and a water outlet section 51. The driving area 52 is received with a gear set 521. The gear set 521 has a plurality of gears which are interactive. A top side of the gear set 521 is engaged to the gear 21 of the water inlet seat 2.

The water outlet section 51 of the supporting seat 5 has two water output holes 511 and two pivotal seats 512. The line connecting the two water output holes 511 is vertical to the line connecting the tow pivotal seats 512. Each pivotal seat 512 has a slot 5121.

A swing seat 54 is installed upon the pivotal seats 512. The swing seat 54 has a base plate 542 which have two long sheets at two ends. A lower side of the base plate 542 has two pivotal posts 543 which are engaged to the two slots 5121 of the pivotal seats 512. A top side of the base plate 542 has two push blocks 541 in one recess of the base plate 542. A limiting space 5411 is formed between the two push blocks 541. The base plate 542 has a through hole 5412 which is communicated to the limiting space 5411. When the base plate 542 is inclined to one side, one of the long sheet of the base plate 542 will cover one of the two water output holes 511.

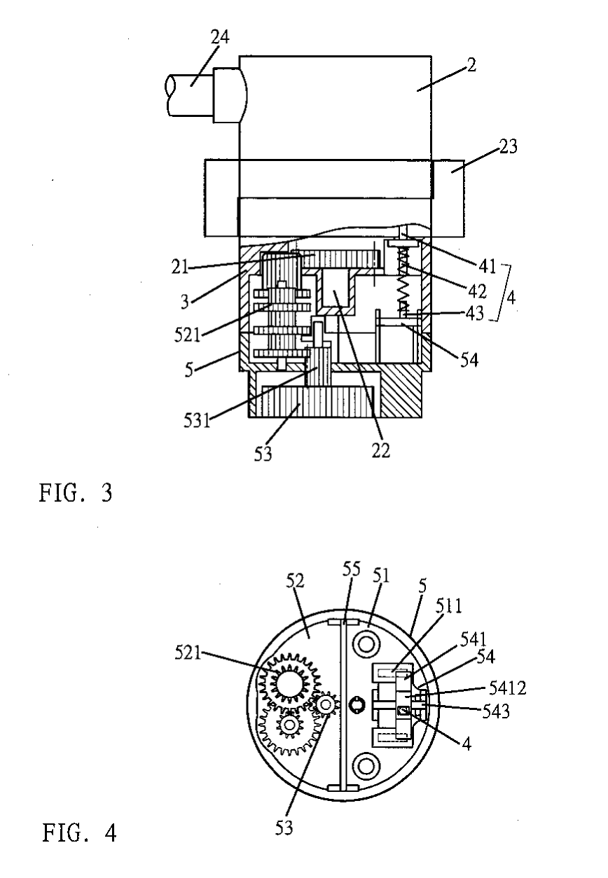

A lower side of the supporting seat 5 is pivoted with a blade wheel 53. A top of the blade wheel 53 is installed with a driving gear 531 which is engaged to the gear set 521 so that the blade wheel 53 is interacted with the gear set 521 (referring to FIGS. 3 and 4).

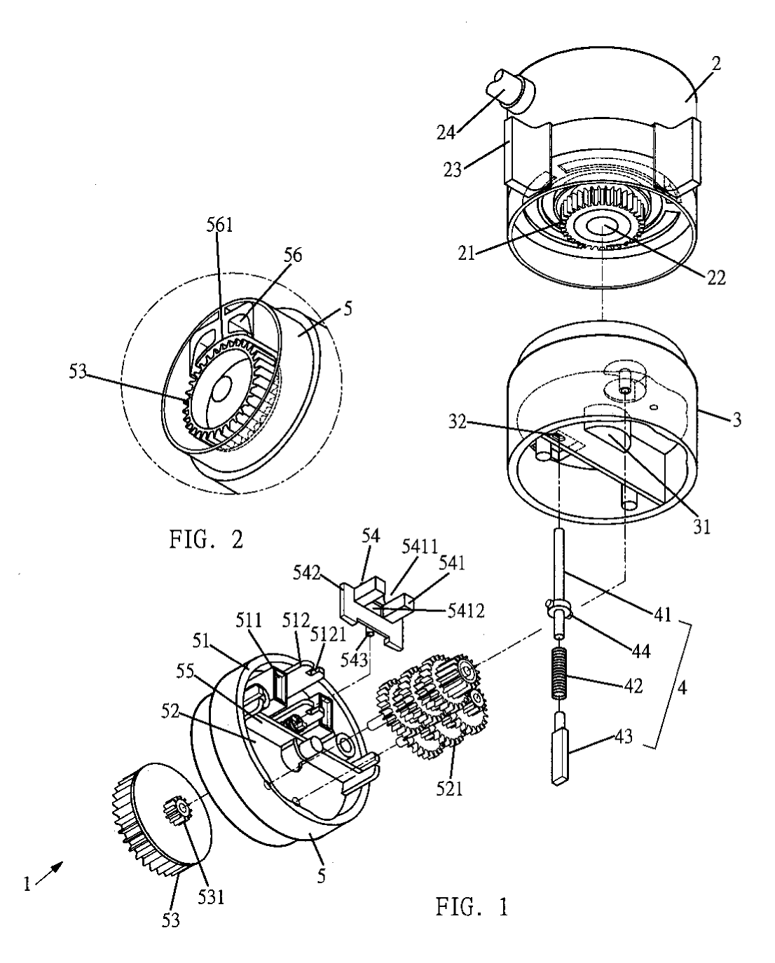

Two water outlets 56 are at a lower side of the supporting seat 5 corresponding to the two water output holes 511. Each water outlet 56 is installed with a flow guide sheet 561 (referring to FIG. 2). By the flow guide sheets 561, the flow directions of the two water outlets 56 are opposite. Thus the blade wheel 53 can rotate by water flow.

Thus, when water flows into the water inlet hole 22 of the water inlet seat 2, the amount of water is adjusted by the inlet valve 24. The water is guided into the rotary seat 3 and the supporting seat 5 from the water inlet hole 31 of the rotary seat 3. The swing seat 54 is swingable installed upon the pivotal seats 512. One of the water output holes 511 is covered by the swing seat 54. Water flows out form the water output hole 511 uncovered by the swing seat 54 to a respective water outlet 56 at a bottom side of the supporting seat 5. By the guiding of the flow guide sheet 561, the blade wheel 53 will rotate along the direction of water flow so as to drive the gear set 521 of the supporting seat 5 to further drive the gear 21 of the water inlet seat 2 (referring to FIGS. 3 and 4). The gear 21 is fixed to the water inlet seat 2. When the gear 21 rotates, the water inlet seat 2 also rotates. Then, the rotary seat 3 rotates with a direction opposite the rotation direction of the water inlet seat 2 so that the rotation direction of the rotary seat 3 is identical to that of the blade wheel 53. Because the supporting seat 5 is firmly secured to the bottom of the rotary seat 3, the supporting seat 5 will drive the rotary seat 3 to rotate.

Further, since the rotary seat 3 is installed with the elastic driver 4. The push rod 41 of the elastic driver 4 extends into the water inlet seat 2. When the rotary seat 3 and supporting seat 5 rotates with respect to the water inlet seat 2, the push rod 41 is driven by the rotary seat 3. The push rod 41 is flexibly connected to the elastic driver 4. The push rod 41 is limited by the limiting projections 23 of the water inlet seat 2 and thus it will be pushed so that the elastic unit 42 will extend to make the movable sheet 43 pushes the swing seat 54 along an opposite direction. The swing seat 54 will cover another water output hole 511. Water flows out from the uncovered water outlet 56. The blade wheel 53 is pushed by water flow and thus to rotate along another direction. Therefore, the blade wheel 53 drives the gear set 521, the gear 21, the rotary seat 3 and the supporting seat 5 to rotate along opposite directions.

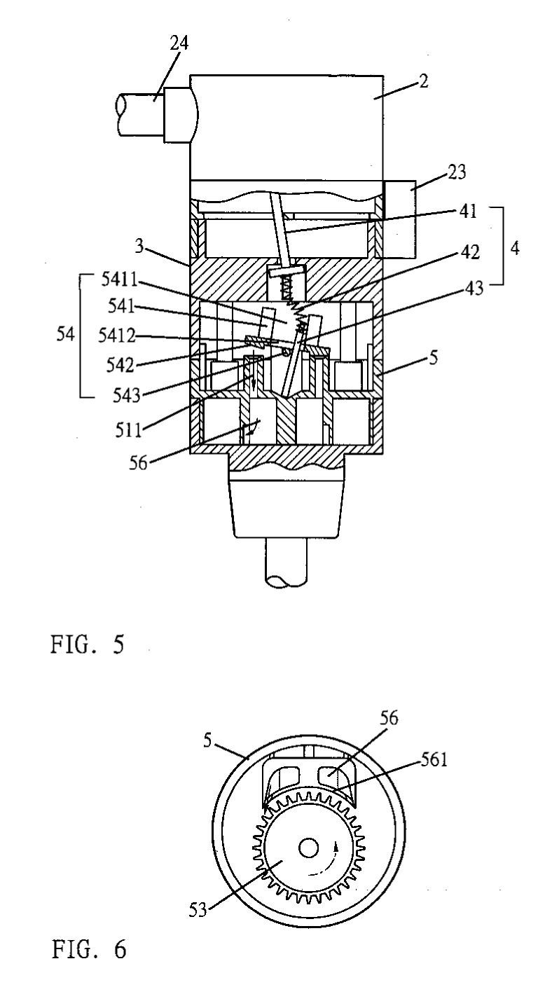

Referring to FIGS. 5 and 6, the operation of the present invention is illustrated. Water enters from the water inlet seat 2 and then flows through the water inlet hole 22 and water inlet hole 31 to the rotary seat 3 and the supporting seat 5. As shown in FIG. 5, the elastic driver 4 uses the movable sheet 43 to push the push block 541 at the right side to cause the swing seat 54 shifts rightwards so as to cover the water output hole 511 at the right side. Then water flows to the water outlet 56 from the left water output hole 511. By the affect of the flow guide sheet 561, water flows out from the left side to drive the blade wheel 53. The blade wheel 53 is driven to rotate counterclockwise (referring to FIG. 6). The top of the blade wheel 53 is installed with the driving gear 53 which will drive the gear set 521. The gear set 521 is engaged to the gear 21 of the water inlet seat 2. Thus the rotary seat 3 and the supporting seat 5 will rotate counterclockwise with respect to the water inlet seat 2.

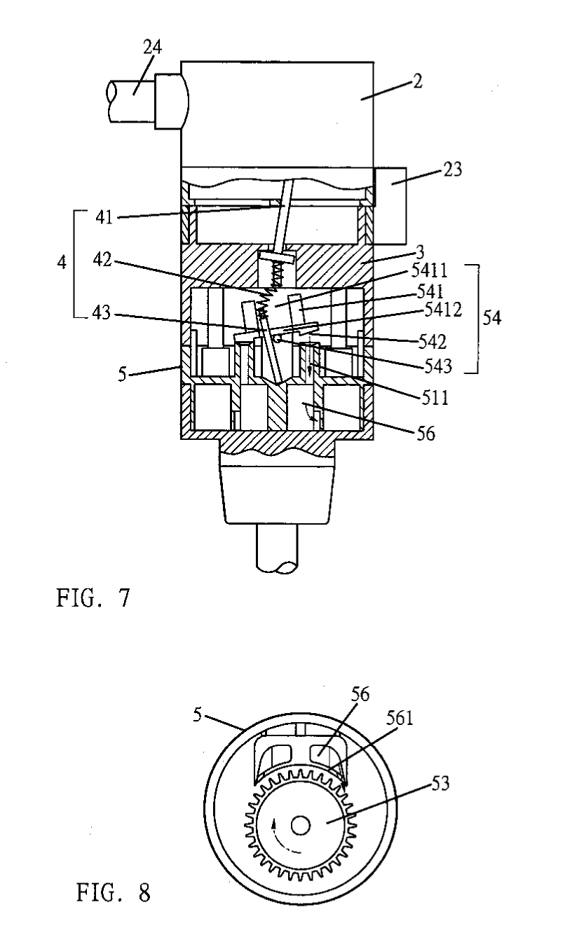

Referring to FIGS. 6 and 7, when the rotary seat 3 and the supporting seat 5 rotate to a predetermined position, the movable sheet 41 will be limited by the limiting projections 23 to shift along an opposite direction, the elastic unit 42 below will bend to the drive the movable sheet 43 to move leftwards. The movable sheet 43 will push the left push block 541 so that the swing seat 54 will move shift leftwards. The left water output hole 511 will be covered. Thus the water flows to the right water output hole 511 and flows out from the right water outlet 56 so as to drive the blade wheel 53 to rotate clockwise (referring to FIG. 8). The blade wheel 53 will drive the driving gear 531, the gear set 521 and the gear 21 so that the rotary seat 3 and the supporting seat 5 rotate clockwise with respect to the water inlet seat 2.

From above FIGS. 5 to 8, it is known that the limiting projections 23 will limit the elastic driver 4 to change the swing seat 54 to cover one of the water output hole 511 so as to make the water flow out from different water outlet 56. Furthermore the rotation directions of the blade wheel 53, supporting seat 5 and the rotary seat 3 are changed.

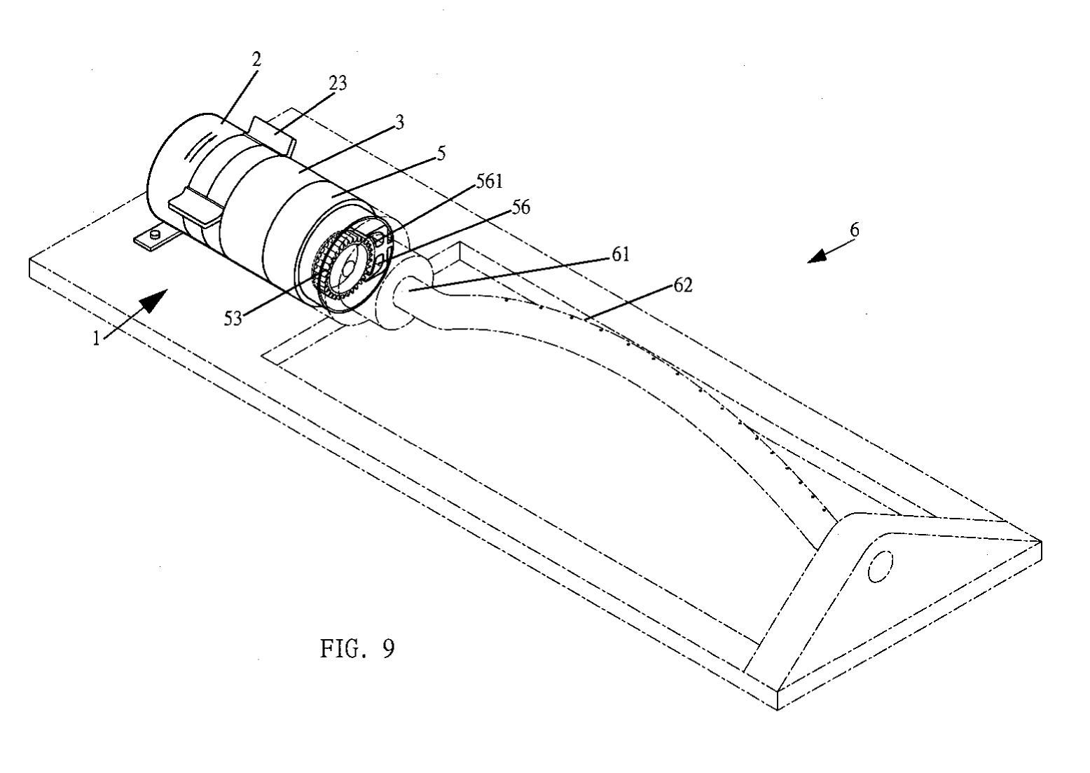

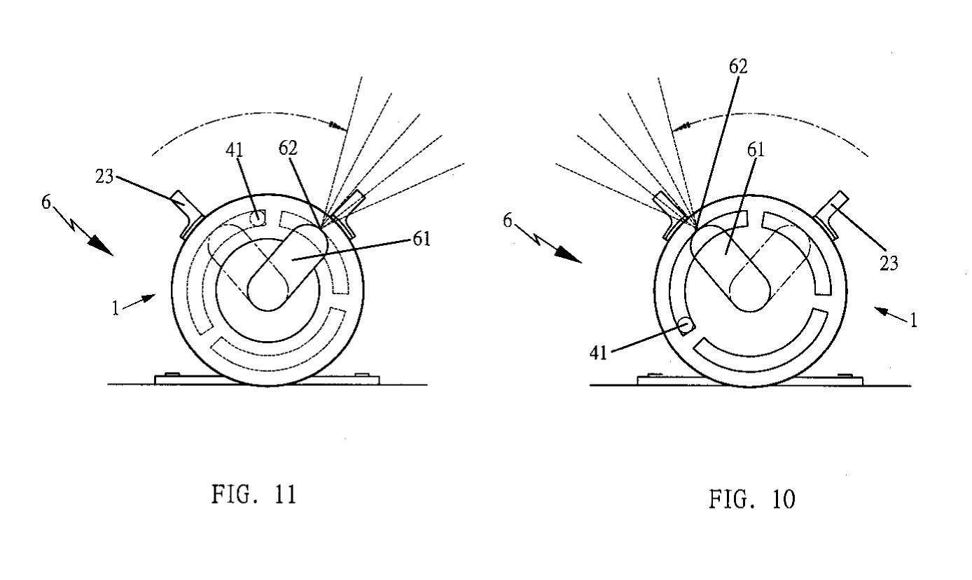

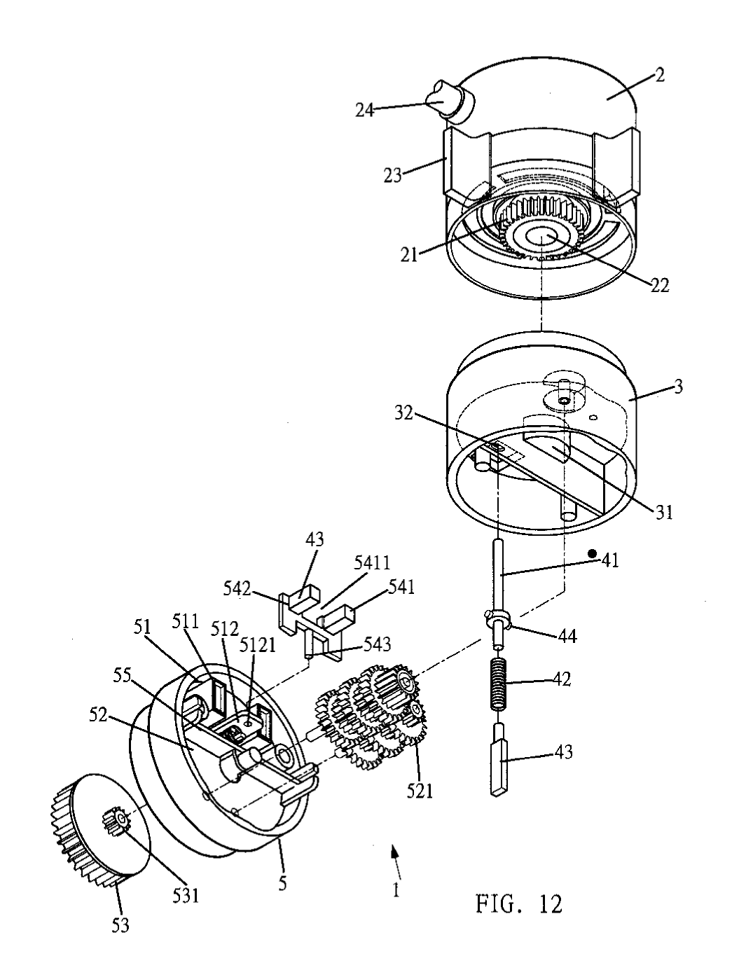

Referring to FIGS. 9 to 11, when the present invention is installed to a spray device 6, the water inlet seat 2 is connected to a water source. A bottom of the supporting seat 5 is connected to a water spray tube 61 which is bended tube. The water spray tube 61 has a plurality of water spray holes. Finally, water is sprayed out from the water spray holes. The two limiting projections 23 have the affect of adjusting the limiting area so that the elastic driver 4 is pushed by the limiting projections 23. Then, the supporting seat 5 and rotary seat 3 will change rotate directions. The water spray tube is connected to the supporting seat 5, which will change direction repeatedly. Therefore, by water force, the direction can be changed automatically.

Referring to FIG. 12, the second embodiment of the present invention is illustrated. In this embodiment, the water outlet section 51 of the supporting seat 5 has two water output holes 511 and one pivotal seat 512. The pivotal seat 512 has a hole 5121. The swing seat 54 is installed upon the pivotal seats 512. The swing seat 54 has an H shape base plate 542 which have two long sheets at two ends. A recess of the base plate 542 is extended with a pivotal post 543 which are engaged to the hole 5121 of the pivotal seat 512. A topside of the base plate 542 has two push blocks 541 in one recess of the base plate 542. A limiting space 5411 is formed between the two push blocks 541. When the base plate 542 is inclined to one side, one of the long sheet of the H shape base plate 542 will cover one of the two water output holes 511.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A water spraying motor, comprising:
a water inlet seat; a bottom of the water inlet seat being installed with a gear; when the gear rotates, the water inlet seat will rotate therewith; a water inlet hole passing through the water inlet seat and the gear for filling water;
a rotary seat connected to the water inlet seat and rotatable with respect to the water inlet seat; the rotary seat having a water inlet hole corresponding to the water inlet hole of the water inlet seat; the rotary seat being installed with a push hole; an elastic driver being installed in the push hole; the elastic driver including a push rod, an elastic unit, and a push sheet; a top of the elastic driver extending into the water inlet seat and being adjusted and confined by the water inlet seat;
a supporting seat; a lower side of the elastic driver extending into the supporting seat; the supporting seat being installed with a supporting seat; the gear set having a plurality of gears which are interactive; a top side of the gear set being engaged to the gear of the water inlet seat;
the supporting seat having two water output holes; a swing seat being installed upon the pivotal seats; the shift of the swing seat will cover one of the two water output holes;
a lower side of the supporting seat being pivoted with a blade wheel; a top of the blade wheel being installed with a driving gear which is engaged to the gear set so that the blade wheel is interacted with the gear set;
two water outlets being at a lower side of the supporting seat corresponding to the two water output holes; water flowing directions of the two water outlets being opposite so that the water from the two water outlets drives the blade wheel to rotate along two opposite directions;
wherein water flows into the water inlet hole of the water inlet seat, when water flows out from one of the water outlet; the blade wheel will be driven, by the engagements of the gear of the water inlet seat, the gear set; the rotary seat will rotate with respect to the water inlet seat; when the rotary seat rotates to a predetermined position, the elastic driver is confined by the water inlet seat so as to push the swing seat along a reverse direction and thus water flows out from another water outlet; and the rotary seat rotates reversely with respect to the water inlet seat so that the rotary seat rotates reciprocally.

2. The water spraying motor as claimed in claim 1, wherein an outer periphery of the water inlet seat is formed with two limiting projections for limiting the space therebetween.

3. The water spraying motor as claimed in claim 1, wherein the elastic driver including a push rod, an elastic unit, and a push sheet; a top of the push rod extends into the water inlet seat and is adjusted and confined by the two limiting projections of the water inlet seat; a lateral side of the push rod near a lower end has two positioning posts for positioning the push rod in the rotary seat; the push rod is rotatable; a lower end of the push rod is engaged with an elastic unit which is a flexible elastic element; a lower end of the elastic unit is installed with a moving sheet.

4. The water spraying motor as claimed in claim 1, wherein each water outlet is installed with a flow guide sheet; by the flow guide sheets, the flow directions of the two water outlets are opposite; thus the blade wheel can rotate by water flow.

5. The water spraying motor as claimed in claim 1, wherein a water inlet seat is an inlet valve at an upper periphery thereof for adjusting flow rate.

6. The water spraying motor as claimed in claim 1, wherein each water outlet is installed with a flow guide sheet; by the flow guide sheets, the flow directions of the two water outlets are opposite; and thus the blade wheel can rotate by water flow.

7. The water spraying motor as claimed in claim 1, wherein the supporting seat has two pivotal seats; the line connecting the two water output holes is approximately vertical to the line connecting the tow pivotal seats; each pivotal seat has a slot.

8. The water spraying motor as claimed in claim 7, wherein the swing seat has a base plate which have two long sheets at two ends; a lower side of the base plate has two pivotal posts which are engaged to the two slots of the pivotal seats; a top side of the base plate has two push blocks in one recess of the base plate; a limiting space is formed between the two push blocks; the base plate has a through hole which is communicated to the limiting space; when the base plate is inclined to one side, one of the long sheet of the base plate will cover one of the two water output holes.

9. The water spraying motor as claimed in claim 1, wherein the supporting seat has one pivotal seat; the pivotal seat has a hole.

10. The water spraying motor as claimed in claim 9, wherein the swing seat is installed upon the pivotal seats; the swing seat has an H shape base plate which have two long sheets at two ends; a recess of the base plate is extended with a pivotal post which are engaged to the hole of the pivotal seat; a topside of the base plate has two push blocks in one recess of the base plate; a limiting space is formed between the two push blocks; when the base plate is inclined to one side, one of the long sheet of the H shape base plate will cover one of the two water output holes.
